(19) United States
(12) Patent Application Publication
(10) Pub. No.: US 2016/0083538 A1
(43) Pub. Date: Mar. 24, 2016

(54) Solvent Resistant, Transparent Aromatic Polyamide Films with High Refractive Indices

(71) Applicant: Akron Polymer Systems, Inc., Akron, OH (US)

(72) Inventors: Limin Sun, Copley, OH (US); Dong Zhang, Uniontown, OH (US); Jiaokai Jing, Uniontown, OH (US); Frank W. Harris, Boca Raton, FL (US)

(21) Appl. No.: 14/841,665

(22) Filed: Aug. 31, 2015

Related U.S. Application Data
(60) Provisional application No. 62/043,513, filed on Aug. 29, 2014.

(51) Int. Cl. C08J 5/18

(52) U.S. Cl. CPC C08J 5/18; C08J 2377/06

(57) ABSTRACT

A solvent resistant, transparent aromatic polyamide film with a high refractive index may be made by reacting at least one aromatic diacid chloride, a first aromatic diamine, and at least one crosslinking agent or a second aromatic diamine in an organic solvent to form an aromatic polyamide polymer in solution. In one embodiment, the at least one aromatic diacid chloride is selected from the group consisting of isophthaloyl dichloride, terephthaloyl dichloride, 2,6-naphthalene-dicarboxylic chloride, or combinations thereof and the first aromatic diamine is selected from the group consisting of 9,9-Bis(4-hydroxyphenyl)fluorine, 2,2′,5,5′-Tetrachlorobenzidine, or combinations thereof. The organic solvent is then evaporated from the aromatic polyamide polymer in solution to form a transparent aromatic polyamide precursor film. The precursor film is then heated at a temperature close to the glass transition temperature of the transparent aromatic polyamide precursor film to form the solvent resistant, transparent aromatic polyamide film.

### RELATED APPLICATION DATA

This application claims priority to U.S. Provisional Application No. 62/043,513, filed Aug. 29, 2014.

### FIELD OF THE INVENTION

The invention relates to the manufacture of thermal stable aromatic polyamides that are soluble in common organic solvents and can be coated on a variety of substrates or cast into a free standing film. More particularly, the invention relates to the use of aromatic polyamides with high glass transition temperatures (Tgs) in the manufacture of solvent resistant, transparent polyamide films with high refractive indices.

### BACKGROUND

Transparent polymer materials are particularly useful in the manufacture of optical components. They are light weight and robust. Polymer films with high refractive indices have attracted particular attention, as they have a variety of potential applications in advanced optoelectronic manufacture, such as organic light emitting diodes (OLED), micro-lens, flexible substrates, anti-reflection layers, etc.

It has proven difficult for such films to achieve wide spread commercial success. Numerous efforts have been made to prepare sulfur containing monomers and polymers therefrom due to sulfer's large molar refraction contribution. However, the polymers have low Tg (˜150 C), are generally not commercially available, are not cost effective, and have limited solubility in common organic solvents.

To increase the Tg of known polymers, sulfur containing polyimides were proposed and prepared. However, the polymers had an absorption near 400 nm and showed some yellow color. It is noted that because inorganic particles usually have much higher refractive indices compared to organic polymers, polymer nano-particle hybrid systems with high refractive index have been proposed. The polymers showed good optical transparency and thermal stability. However, it was not easy to scale up the production of these polymers.

In order for polymer films to be commercially viable, they must offer more than high transparency and a high refractive index. They must be solution cast, yet solvent resistant in use. They must be thermally stable in order to survive the processing conditions required for their incorporation in optoelectronic devices. They must also be dimensionally stable under these conditions. Thus, they must have a high glass transition temperature (Tg) and a low coefficient of thermal expansion (CTE).

### SUMMARY OF THE INVENTION

A solvent resistant, transparent aromatic polyamide film with a high refractive index may be made by reacting at least one aromatic diacid chloride, a first aromatic diamine, and at least one crosslinking agent or a second aromatic diamine in an organic solvent to form an aromatic polyamide polymer in solution. In one embodiment, the at least one aromatic diacid chloride is selected from the group consisting of isophthaloyl dichloride, terephthaloyl dichloride, 2,6-naphthalene-dicarboxylic chloride, or combinations thereof and the first aromatic diamine is selected from the group consisting of 9,9-Bis(4-hydroxyphenyl)fluorine, 2,2′,5,5′-Tetrachlorobenzidine, or combinations thereof. The organic solvent is then evaporated from the aromatic polyamide polymer in solution to form a transparent aromatic polyamide precursor film. The precursor film is then heated at a temperature close to the glass transition temperature of the transparent aromatic polyamide precursor film to form the solvent resistant, transparent aromatic polyamide film. It has been surprisingly found that films made according to this method retain a high refractive index, of about at least, 1.650, while becoming solvent resistant.

### DETAILED DESCRIPTION OF THE INVENTION

Solvent resistant, transparent films with high refractive indices are made from soluble, aromatic polyamides with high glass transition temperatures (Tgs). The films are cast from solutions of the polyamides in polar aprotic solvents. A cross linking agent is added to the polymer solution prior to casting or a functional group that can be used to affect cross linking is first incorporated in the polyamide through the use of an appropriate monomer. After the film is cast to form a precursor film, it is heated so as to develop solvent resistance, while maintaining the high thermal stability, high transparency, and high refractive indices that are associated with the soluble aromatic polyamides.

In one embodiment, an aromatic polyamide may be made by the polymerization of at least one aromatic diacid chloride and an aromatic diamine in an organic solvent, such as DMAc at 0° C. Surprisingly, we have discovered that certain aromatic diamines can be used to increase the solubility of the polyamide and the refractive index of the film prepared therefrom. The hydrochloric acid generated in the reaction between the diacid chloride and the aromatic diamine may be trapped by reaction with a reagent like propylene oxide (PrO) or an inorganic salt. A crosslinking agent, such as a multifunctional epoxy resin or a multifunctional aromatic carboxylic acid, may then be added to the polymerization mixture.

After polymerization, the resultant polymer solution may be directly cast onto a substrate to form a precursor film or the polymer may be first isolated from the polymer solution by precipitation in a non-solvent, such as methanol. After isolation, the dried polymer may then be redissolved in a common organic solvent, such as N,N-dimethylacetamide (DMAc), N-methylpyrrolidone (NMP), or gamma-butyrolactone (GBL), and the cross linking agent added.

In another embodiment, a functional group that can affect cross linking, such as a carboxyl group, may be attached to the polyamide backbone through the use of an appropriately substituted diamine monomer. This monomer is used along with the diamine that contributes to the film refractive index in the polymerization with the diacid chloride. The polymerization is carried out as described above. However, in this case, there is no need to add an extra cross linking agent to the polymerization mixture. Although, in some cases, a small amount may be added to allow cross linking at a lower temperature.

In all of the approaches described above, a transparent film can be prepared by coating or casting the polymer solution onto a flat substrate, such as a glass plate to form a precursor film. The transparent precursor film may then be cross linked by heating at an elevated temperature, i.e. a temperature close to the glass transition temperature (Tg) of the aromatic polyamide, to impart solvent resistance to the film. The solvent resistant film maintains the high refractive indices, high transparency, and high refractive indices of the uncured film

The polyamide films generally have high optical transparency over a range of 400˜750 nm (a transmittance greater than about 50% at 400 nm), a low coefficient of thermal expansion (CTE less than about 60 ppm/° C.), a high glass transition temperature (Tg greater than about 270° C.) and a high refractive index (higher than 1.6500). The cross linked film is considered solvent resistant if it is substantially free of surface wrinkles, swelling, or any other visible damage after immersion in an organic solvent.

As stated above, the polyamides useful in this invention may be formed by combining at least one aromatic diacid dichloride and at least one aromatic diamine. In one embodiment, the aromatic diacid dichlorides suitable for preparing the aromatic polyamides may include, but are not limited to:

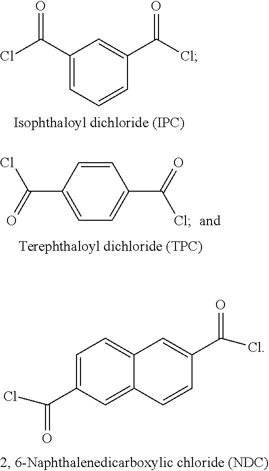 [SMILES: O=C(Cl)c1cccc(C(=O)Cl)c1 ; O=C(Cl)c1ccc(C(=O)Cl)cc1 ; O=C(Cl)c1ccc2cc(C(=O)Cl)ccc2c1]

The aromatic diamines suitable for preparing the polyamides may include, but are not limited to:

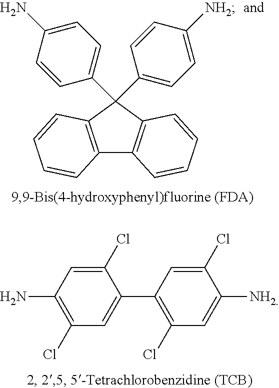 [SMILES: Nc1ccc(C2(c3ccc(N)cc3)c3ccccc3-c3ccccc32)cc1 ; Nc1cc(Cl)c(-c2cc(Cl)c(N)cc2Cl)cc1Cl]

The films prepared from polyamides based on such diamines display high refractive indices.

The multifunctional epoxy compounds that can be used as cross linking agents include, but are not limited to:

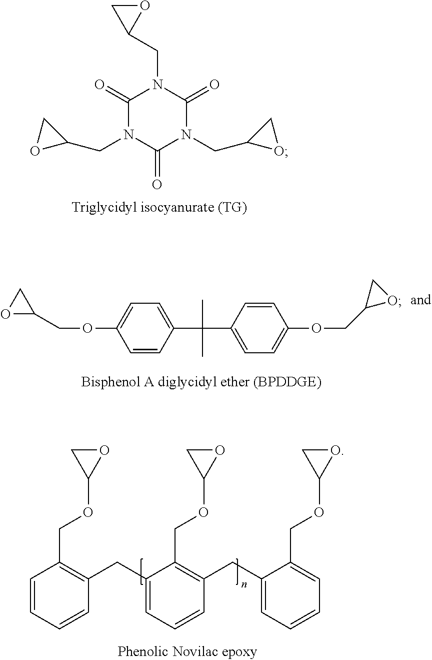

The multifunctional aromatic carboxylic acids that can be used as cross linking agents include, but are not limited to:

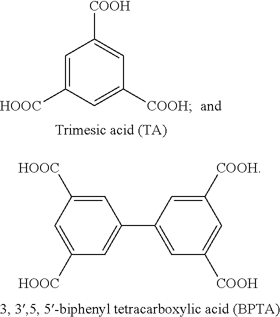 [SMILES: O=C(O)c1cc(C(=O)O)cc(C(=O)O)c1 ; O=C(O)c1cc(C(=O)O)cc(-c2cc(C(=O)O)cc(C(=O)O)c2)c1]

Monomers that can be used to prepare polyamides containing pendant carboxyl groups include, but are not limited to:

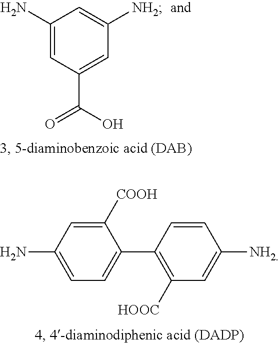 [SMILES: Nc1cc(N)cc(C(=O)O)c1 ; Nc1ccc(-c2ccc(N)cc2C(=O)O)c(C(=O)O)c1]

In one embodiment, an aromatic polyamide may be prepared using a combination of TPC and IPC along with a diamine. In this embodiment, the molar ratio of TPC to IPC may be from 0:100 to 70:30, and preferably from 60:40 to 70:30. If DAB is added to the diamine, the molar ratio of the TPC to IPC can be from 0:100 to 90:10, but preferably about 90:10. In another embodiment, when DAB or DADP are used to effectuate the crosslinking, those diamines are generally present in an amount of about one (1) to about ten (10) molar percent, and desirably about five (5) molar percent, of the diamine content. If a multifunctional epoxy compound or multifunctional aromatic carboxylic acid is used as the crosslinking agent, those compounds are generally present in an amount that is from about 1 to 10, and desirably about 5, weight percent of the aromatic polyamide polymer.

### Preparation of Polymer Solutions

### EXAMPLE 1

This example illustrates the general procedure to prepare an aromatic polyamide solution from a mixture of acid dichlorides (TPC, IPC, and/or NDC) and at least one a diamine (FDA or TCB). The general chemical reaction formula is shown below:

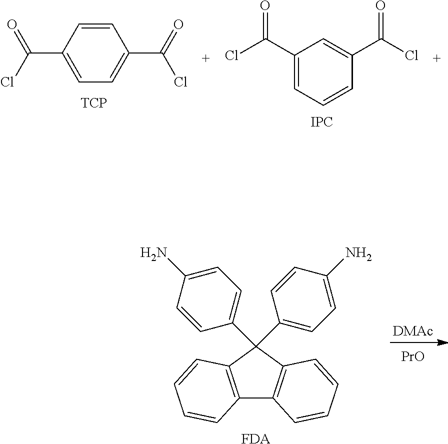

In one experiment, approximately 87.11 g (0.25 mol) of 9,9-bis(4-aminophenyl)fluorine (FDA), 44 g (0.75 mol) propylene oxide (PrO), and 1014 g of dimethylacetamide (DMAc) were added to a 2 L three-necked round bottom flask equipped with a nitrogen inlet and out let and a mechanical stirrer. Once the FDA was totally dissolved, the resulting solution was cooled in an ice-water bath. To the cooled resulting solution, approximately 15.23 g (0.075 mol) of isophthaloyl dichloride (IPC) was added to the flask. Then, approximately 35.53 g (0.175 mol) terephthaloyl dichloride (TPC) was added in several portions over two (2) hours. The dichloride/diamine solution was then allowed to stir at room temperature for another 6 hours to form the polymer solution. The polymer solution was then used for film preparation. Alternatively, the pure polymer may be isolated by precipitation in a large amount of methanol, soaking the polymer in fresh methanol several times, and then drying under reduced pressure. The polymer may be then redissolved in an organic solvent.

### EXAMPLE 2

This example illustrates the general procedure used to prepare a solution of a polyamide containing pendant carboxylic acid groups. The polymer solution may be made from a mixture of dichlorides (TPC, IPC, and/or NDC) and a mixture of diamines, including at least one with a free pendant carboxylic acid group (FDA or TCB and DAB). The general chemical reaction formula is shown below:

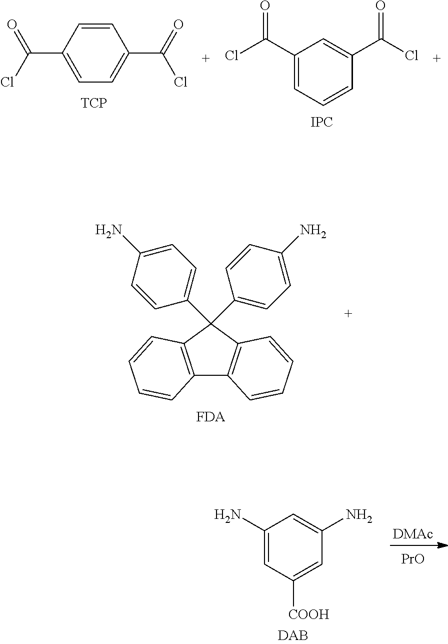

In one experiment, approximately 3.3101 g (0.0095 mol) FDA, 0.0761 g (0.0005 mol) 3,5-diaminobenzoic acid (DAB), 4.4 g (0.075 mol) (PrO), and 38 g DMAc were added to a 250 ml three necked round bottom flask equipped with a nitrogen inlet and out let and a mechanical stirrer. Once the diamines were completely dissolved, the solution was cooled in an ice-water bath. To the solution, approximately 0.2030g (0.001 mol) of IPC was added to the flask. Then, approximately 1.8272 g (0.009 mol) of TPC was added in several portions over 2 hours. The acid dichlorides/diamine solution was then allowed to stir at room temperature for another 6 hours. The solution was then used for film preparation. Alternatively, the polymer may be isolated by precipitating the polymer in a large amount of methanol, soaking the precipitated polymer in fresh methanol several times, and then drying it under reduced pressure. the polymer may then be redissolved in an organic solvent.

### EXAMPLES 3 AND 4

These examples illustrate the general procedure used to prepare polyamide solutions containing multifunctional epoxy compounds (example 3) and multifunctional aromatic carboxylic acids (example 4). Polymer solutions are first prepared as described in Example 1 and then either TG or TA is added (an amount equivalent to 5 wt % of the polymer). The polymer solutions contain a total of about 10 wt % solids.

### Preparation of Films

The polymer solutions are spread on a glass substrate using a doctor blade. The solvent is allowed to evaporate at 60° C. for one hour and the film is then dried at 160° C. under reduced pressure for 12 hours. No further heating is required for films containing multifunctional epoxy compounds. However, films containing multifunctional aromatic carboxylic acids and those prepared from polyamides containing pendant carboxyl groups are further heated at an elevated temperature close to the Tg of the polyamide for 30 minutes and then removed from the glass plate. Films prepared in this manner are approximately 10 to 20 microns thick.

### Characterization of Films

The transmittance of the films 10 microns thick was measured with a Shimadzi UV-2450 spectrometer. The glass transition temperature (Tg) and the coefficient of thermal expansion (CTE) of films 20 μm thick were measured with a TA Instruments Q400 Thermal Mechanical Analyzer (TMA). The refractive indices of the 10 micron films along the nx and ny axes (in plane) and nz axes (out of plane) were determined on a Metricon Prism Coupler 2010/M at 633 nm for approximately 10 μm thick film. The average refractive index for the resulting films was determined using the following equation:

RI=(nx+ny+nz)/3

The out of plane birefringence was determined using the following equation:

Δn=nz−(nx+ny)/2

### Film Properties

The properties of the films cast from polymer solutions that were prepared according to the procedure described in example 1, are shown in Table 1. (These films do not contain any cross linking agent).

TABLE 1

| | | | | Dissolve | Tg | CTE | T % | | |
|---|---|---|---|---|---|---|---|---|---|
| Polymer | M1¹ | M2 | M3 | In NMP | (° C.) | (ppm/° C.) | (400 nm) | RI | Δn |
| 1 | TPC | IPC | FDA | Yes | 397 | 52 | 74 | 1.686 | −0.013 |
| | 70 | 30 | 100 | | | | | | |
| 2 | TPC | IPC | TCB | Yes | 270 | 19.1 | 80 | 1.687 | −0.102 |
| | 60 | 40 | 100 | | | | | | |
| 3 | NDC | — | FDA | Yes | 413 | 53 | 49 | 1.703 | −0.035 |
| | 100 | | 100 | | | | | | |

¹M1, M2, M3, refer to Monomers 1, 2, and 3. Tg refers to the glass transition temperature (° C.), CTE refers to the coefficient of thermal expansion (ppm/° C.) between 50~200° C., T % refers to the transmittance at 400 nm, RI refers to the refractive index (633 nm); and Δn refers to the birefringence (633 nm).

The properties of the films cast from polymer solutions that were prepared according to the procedure described in Example 3, are shown in Table 2. Thus, the films contained the cross linking agent TG. The mass ratio between the cross linking agent TG and the polyamide was 5 to 100. The polymer film was heated at 160° C. for 12 hours under reduced pressure. The solvent resistance of the film was determined by immersing it in NMP for 30 minutes at room temperature.

TABLE 2

| | | | | | Dissolve | Tg | CTE | T % | | |
|---|---|---|---|---|---|---|---|---|---|---|
| Polymer | M 1 | M2 | M3 | TG % | In NMP | (° C.) | (ppm/° C.) | (400 nm) | RI | Δn |
| 4 | TPC | IPC | FDA | 5 | No | 375 | 51 | 76 | 1.6836 | −0.013 |
| | 70 | 30 | 100 | | | | | | | |
| 5 | TPC | IPC | TCB | 5 | No | 343 | 19.4 | 79 | 1.685 | −0.098 |
| | 60 | 40 | 100 | | | | | | | |
| 6 | NDC | IPC | FDA | 5 | No | 391 | 45 | 56.9 | 1.703 | −0.033 |
| | 100 | 0 | 100 | | | | | | | |

The properties of the films cast from polymer solutions that were prepared according to the procedure described in Example 4, are shown in Table 3, Thus, the films contained the cross linking agent TA. The mass ratio between the cross linking agent and the polyamide was 5 to 100. The film was heated to near the polymer Tg for 30 minutes. The solvent resistance of the film was determined by immersing it in NMP at room temperature for 30 minutes at room temperature.

TABLE 3

| | | | | | Cure | | | | | | |
|---|---|---|---|---|---|---|---|---|---|---|---|
| | | | | | Temp | Dissolve | Tg | CTE | T % | | |
| Polymer | M1 | M2 | M3 | TA % | ° C. | In NMP | (° C.) | (ppm/° C.) | (400 nm) | RI | Δn |
| 7 | TPC | IPC | FDA | 5 | 350 | No | 385 | 62 | 65 | 1.689 | −0.002 |
| | 70 | 30 | 100 | | | | | | | | |
| 8 | TPC | IPC | TCB | 5 | 280 | No | 272 | 38 | 66 | 1.691 | −0.083 |
| | 60 | 40 | 100 | | | | | | | | |
| 9 | NDC | IPC | FDA | 5 | 350 | No | 389 | 62 | 53 | 1.708 | −0.015 |
| | 100 | 0 | 100 | | | | | | | | |

The properties of the films cast from the polymer solutions that were prepared according to the procedure described in Example 2 are shown in Table 4. Thus, the films contained polyamides with pendant carboxyl groups. The films were heated to near the polymer Tg for 30 minutes. The solvent resistance of the film was determined by immersing it in NMP at room temperature for 30 minutes.

TABLE 4

| | | | | | Cure | | | | | | |
|---|---|---|---|---|---|---|---|---|---|---|---|
| | | | | | Temp | Dissolve | Tg | CTE | T % | | |
| Polymer | M1 | M2 | M3 | M4 | (° C.) | In NMP | (° C.) | (ppm/° C.) | (400 nm) | RI | Δn |
| 10 | TPC | IPC | FDA | DAB | 350 | No | 399 | 54 | 70 | 1.687 | −0.014 |
| | 90 | 10 | 95 | 5 | | | | | | | |
| 11 | TPC | IPC | TCB | DAB | 330 | No | 277 | 33.6 | 55 | 1.696 | −0.085 |
| | 90 | 10 | 95 | 5 | | | | | | | |
| 12 | NDC | IPC | FDA | DAB | 350 | No | 400 | 49 | 52 | 1.709 | −0.026 |
| | 100 | 0 | 95 | 5 | | | | | | | |

As shown from the data above, by heating the various polymer films to about 350° C., or a temperature close to the glass transition temperature of the polymer, and adding a crosslinking agent or a second diamine, the film transformed from one soluble in organic solvents to one that was solvent resistant, while maintaining the desirable optical properties described herein.

While example methods and compositions have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, devices, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather the scope of the invention is to be determined by the appended claims and their equivalents.

We claim:

1. A method of making a solvent resistant, transparent aromatic polyamide film with a high refractive index comprising the steps of:
reacting at least one aromatic diacid chloride, a first aromatic diamine, and at least one crosslinking agent or a second aromatic diamine in an organic solvent to form an aromatic polyamide polymer in solution; wherein the at least one aromatic diacid chloride is selected from the group consisting of isophthaloyl dichloride, terephthaloyl dichloride, 2,6-naphthalene-dicarboxylic chloride, or combinations thereof and the first aromatic diamine is selected from the group consisting of 9,9-Bis(4-hydroxyphenyl)fluorine, 2,2′,5,5′-Tetrachlorobenzidine, or combinations thereof;
evaporating the organic solvent from the aromatic polyamide polymer in solution to form a transparent aromatic polyamide precursor film; and
heating the transparent aromatic polyamide precursor film at a temperature close to the glass transition temperature of the transparent aromatic polyamide precursor film to form the solvent resistant, transparent aromatic polyamide film.

2. The method of claim 1, wherein the at least one aromatic diacid chloride consists of a mixture of terephthaloyl dichloride and isophthaloyl dichloride in a molar ratio of about 0:100 to about 70:30, respectively.

3. The method of claim 2, wherein the molar ratio of terephthaloyl dichloride to isophthaloyl dichloride is about 60:40 to about 70:30, respectively.

4. The method of claim 1, wherein the first aromatic diamine is 9,9-Bis(4-hydroxyphenyl)fluorine.

5. The method of claim 1, wherein the method comprises the crosslinking agent and the crosslinking agent is a multi-functional epoxy compound or an aromatic carboxylic acid compound present in an amount of about 1 to about 10 weight percent of the aromatic polyamide polymer.

6. The method of claim 5, wherein the crosslinking agent is a multifunctional epoxy compound selected from the group consisting of triglycidyl isocyanurate, bisphenol A diglycidyl ether, phenolic novilac epoxy, or combinations thereof.

7. The method of claim 6, wherein the multifunctional epoxy compound is triglycidyl isocyanurate.

8. The method of claim 5, wherein the crosslinking agent is an aromatic carboxylic acid compound selected from the group consisting of trimesic acid, 3,3′,5,5′-biphenyl tetracarboxylic acid, and combinations thereof.

9. The method of claim 8, wherein the aromatic carboxylic acid compound is trimesic acid.

10. The method of claim 1, wherein the method comprises the second aromatic diamine present in an amount of about 1 to about 10 molar percent of a combination of the first aromatic diamine and the second aromatic diamine; and wherein the second aromatic diamine is a monomer that can be used to prepare polyamides containing pendant carboxyl groups.

11. The method of claim 10, wherein the monomer is selected from the group consisting of 3,5-diaminobenzoic acid, 4,4′-diaminodiphenic acid, and combinations thereof.

12. The method of claim 11, wherein the monomer is 3,5-diaminobenzoic acid.

13. The method of claim 1, wherein the organic solvent is selected from the group consisting of N,N-dimethylacetamide, N-methyl-pyrrolidone, gamma-butyrolactone, or a combination thereof.

14. The method of claim 13, wherein the organic solvent is N,N-dimethylacetamide.

15. The method of claim 1, wherein the step of evaporating the organic polymer from the crosslinked polymer solution to form a transparent aromatic polyamide precursor film further comprises drying the crosslinked polymer solution at a temperature of about 160° C.

16. The method of claim 1, wherein the step of heating the transparent aromatic polyamide precursor film at a temperature close to the glass transition temperature of the transparent aromatic polyamide precursor film is performed for at least about 30 minutes.

17. A solvent resistant, transparent aromatic polyamide film with a high refractive index made by:
reacting at least one aromatic diacid chloride, a first aromatic diamine, and at least one crosslinking agent or a second aromatic diamine in an organic solvent to form an aromatic polyamide polymer in solution; wherein the at least one aromatic diacid chloride is selected from the group consisting of isophthaloyl dichloride, terephthaloyl dichloride, 2,6-naphthalene-dicarboxylic chloride, or combinations thereof and the first aromatic diamine is selected from the group consisting of 9,9-Bis(4-hydroxyphenyl)fluorine, 2,2′,5,5′-Tetrachlorobenzidine, or combinations thereof;
evaporating the organic solvent from the aromatic polyamide polymer in solution to form a transparent aromatic polyamide precursor film; and
heating the transparent aromatic polyamide precursor film at a temperature close to the glass transition temperature of the transparent aromatic polyamide precursor film to form the solvent resistant, transparent aromatic polyamide film.

18. The film of claim 17, wherein the at least one aromatic diacid chloride consists of a mixture of terephthaloyl dichloride and isophthaloyl dichloride in a molar ratio of about 0:100 to about 70:30, respectively.

19. The film of claim 18, wherein the molar ratio of terephthaloyl dichloride to isophthaloyl dichloride is about 60:40 to about 70:30, respectively.

20. The film of claim 17, wherein the first aromatic diamine is 9,9-Bis(4-hydroxyphenyl)fluorine.

21. The film of claim 17, wherein the film is made using the crosslinking agent and the crosslinking agent is a multi-functional epoxy compound or an aromatic carboxylic acid compound present in an amount of about 1 to about 10 weight percent of the aromatic polyamide polymer.

22. The film of claim 21, wherein the crosslinking agent is a multifunctional epoxy compound selected from the group consisting of triglycidyl isocyanurate, bisphenol A diglycidyl ether, phenolic novilac epoxy, or combinations thereof.

23. The film of claim 22, wherein the multifunctional epoxy compound is triglycidyl isocyanurate.

24. The film of claim 21, wherein the crosslinking agent is an aromatic carboxylic acid compound selected from the group consisting of trimesic acid, 3,3′,5,5′-biphenyl tetracarboxylic acid, and combinations thereof.

25. The film of claim 24, wherein the aromatic carboxylic acid compound is trimesic acid.

26. The film of claim 1, wherein the film is made using the second aromatic diamine present in an amount of about 1 to about 10 molar percent of a combination of the first aromatic diamine and the second aromatic diamine; and wherein the second aromatic diamine is a monomer that can be used to prepare polyamides containing pendant carboxyl groups.

27. The film of claim 26, wherein the monomer is selected from the group consisting of 3,5-diaminobenzoic acid, 4,4′-diaminodiphenic acid, and combinations thereof.

28. The film of claim 27, wherein the monomer is 3,5-diaminobenzoic acid.

29. The film of claim 17, wherein the transparent aromatic polyamide precursor film is heated to a temperature close to the glass transition temperature of the transparent aromatic polyamide precursor film for at least about 30 minutes.

30. The film of claim 17, wherein the refractive index of the film is at least about 1.650.
